(19) United States
(12) Patent Application Publication
(10) Pub. No.: US 2025/0223852 A1
(43) Pub. Date: Jul. 10, 2025

(54) DOOR-HINGE JIG

(71) Applicant: Trend Tool Technology Ltd, Watford, Hertfordshire (GB)

(72) Inventors: Jemimah Minnigin; Andrew Trainer

(21) Appl. No.: 18/852,960

(22) PCT Filed: Jul. 25, 2023
(86) PCT No.: PCT/GB2023/051954

§ 371 Date: Sep. 30, 2024

(30) Foreign Application Priority Data
Jul. 25, 2022 (GB) 2210813.8

(51) Int. Cl. E05D 11/00

(52) U.S. Cl. CPC E05D 11/0009; E05Y 2900/132

(57) ABSTRACT

A door-hinge jig for forming hinge-receiving recesses in a door edge or door frame includes an elongate body (having at least one longitudinal rail element connected by at least two rail members), at least one hinge-recess guide element (defining a guide channel and including engagement means), and at least one connector element for connecting two rail members. The engagement means engage with the at least one longitudinal rail element to set a longitudinal position of the guide element. Each hinge-recess guide element is located in a recess guide region extending continuously along a length of a longitudinal rail element. A hinge-recess guide element is selectively positionable to define a position of a guide channel in the recess guide region without obstruction or interference by a remotely located connector element.

The present invention relates to a door-hinge jig for forming or marking hinge receiving recesses in a door edge or door frame.

Hinging a door requires that the position of the hinges on the door match their corresponding positions on the doorframe. Traditionally this would be achieved by first creating recesses on the door into which one part of the hinge will fit. The door is offered up to the doorframe to enable marking. The corresponding recesses are then formed on the doorframe to receive the other leaf of the hinge. This process requires skill and practice, not only to correctly position the two leaves of each hinge, but also to make sure that the length, width and depth of the cut recesses are sufficient to receive the hinge without the door binding on the doorframe when closed, whilst also allowing the door to latch closed neatly and without excessive gaps.

In order to facilitate the process, it is known to provide a hinge jig having one or more guide channels for forming hinge recesses in a door edge or door frame using a router. In a basic arrangement, a hinge jig may comprise a guide channel having appropriate dimensions to provide a recess with the appropriate length and width. The jig may be positioned on the door edge or door frame in the position of a desired hinge recess, and then moved into position to form another recess or the same or another door edge or door frame. Such hinge jigs still require accurate positioning to ensure the recesses are formed in the correct positions in the corresponding door edge and door frame.

It is also known to provide hinge jigs having a plurality of guide channels at predefined positions corresponding to standard hinge positions. Accordingly, correct positioning of the hinge recesses relative to each other on a door edge can be ensured, and identical recesses on a corresponding door frame can also be formed with the same relative positions using the same jig.

It is further known to provide adjustable hinge-recess guide elements, allowing the positions and dimensions of the guide channels to be adjusted according to the particular installation. Once the positions and dimensions of the guide channels have been set, the same jig can be used to form corresponding recesses on both the door edge and the door frame, thus ensuring that the hinges are in the correct positions when the door is hung.

Hinge jigs of this type must necessarily be relatively long (typically greater than 6 foot or 1.8 m) in order to provide guide channels along the entire length of the door frame or door edge (i.e. in order to set the relative positions of at least the uppermost and lowermost hinges). It is therefore desirable that the hinge jig is of a modular construction, allowing disassembly for ease of storage and transport, and subsequent assembly for use. However, modular hinge jigs have hitherto been limited in the positioning of the guide channels along the length of the jig. That is to say, there are certain longitudinal positions along the length of the jig in which it is not possible to position a guide channel due to the constructional limitations of the modular hinge jig.

The present invention seeks to provide an improved hinge jig of modular construction which allows for uninhibited positioning of the guide channels.

According to the present invention there is provided a door-hinge jig for forming hinge-receiving recesses in a door edge or door frame, the jig comprising:
an elongate body comprising at least one longitudinal rail element, the or each longitudinal rail element comprising at least two rail members arranged to be connected together to form the respective longitudinal rail element;
at least one hinge-recess guide element at least partially defining a guide channel for forming a hinge recess in a door or doorframe, the or each hinge-recess guide element comprising engagement means for engaging the hinge-recess guide element with the at least one longitudinal rail element to set a longitudinal position of the hinge-recess guide element on the longitudinal rail element; and
at least one connector element arranged to connect said two adjacent rail members together,
wherein the jig defines a recess guide region extending continuously along substantially the entire length of the longitudinal rail element,
and wherein, in use, the or each hinge-recess guide element is located within said recess guide region so as to at least partially define a position of a guide channel within said recess guide region, and the or each connector element is remote from the recess guide region, such that the or each hinge-recess guide element is arranged to be selectively positioned within the recess guide region at any longitudinal position along the length of the or each longitudinal guide element, without obstruction or interference by the connector element.

In the context of the present invention, the term “extending continuously along substantially the entire length of the longitudinal rail element” is to be interpreted as meaning that the recess guide region extends from a first end region of the longitudinal rail element to a second end region of the longitudinal rail element. It will be appreciated that this may not require the recess guide region to extend to the absolute end points of the longitudinal rail element in the longitudinal direction.

The recess guide region is a region adjacent the or each longitudinal rail element, which extends continuously along substantially the entire length of the longitudinal rail element, in which the or each hinge-recess guide element is located, in use. By being remote from the recess guide region, it is to be understood that the connector element does not extend into or otherwise obstruct the recess guide region. That is, the or each connector element does not extend into or otherwise obstruct the region adjacent the longitudinal rail element in which a hinge-recess guide element may be located.

With the arrangement of the present invention, the or each longitudinal rail element and the engagement means of the or each hinge-recess guide element are arranged to permit the or each hinge-recess guide element to be selectively positioned within the recess guide region at any longitudinal position along the length of the longitudinal guide element, without obstruction or interference by the connector element, which is remote from the recess guide region. The or each longitudinal rail element provides a support on which the hinge-recess guide element(s) can be mounted, which can have the necessary length to extend along substantially the entire length of a door edge or door frame in use, but which can be disassembled by disconnecting the rail members for ease of storage and transportation. The or each longitudinal rail element and the engagement means of the or each hinge-recess guide element are arranged to permit the or each hinge-recess guide element to be selectively positioned within the recess guide region at any longitudinal position along the length of the longitudinal guide element.

Accordingly, the hinge jig has a modular construction by virtue of the at least two connectable rail members, without limitation to the longitudinal position of the hinge-recess guide element(s) along the length of the longitudinal rail element. The guide channels can therefore be positioned at any desired longitudinal position along the length of the elongate body and can thus be used to form or mark hinge recesses in a door edge or door frame in any standard or non-standard position (within the constraints set by the locations of other hinge-recess guide elements engaged with the same longitudinal rail element). The present invention therefore provides an improved hinge jig of modular construction which allows for more versatile positioning of the guide channels.

Moreover, it is possible to provide a plurality of rail members allowing the overall length of the or each longitudinal rail element, and thus of the elongate body of the hinge jig, to be adjusted according to the application. For example, a shorter elongate body can be constructed by connecting only two rail members. The length of the elongate body can then be increased by connecting a third rail member to one of the first two rail members by means of a further connector element. Alternatively, second and third rail members may have specific, non-equal lengths, such that connection of either the second or the third rail member with the same first rail member provides elongate bodies with different lengths. The or each longitudinal rail element may comprise first and second rail members having specific, non-equal lengths. The or each longitudinal rail element may comprise first, second and third rail members having specific, non-equal lengths.

The length of the longitudinal rail element is preferably defined by the combined length of the constituent rail members forming the longitudinal rail element.

The or each hinge-recess guide element is moveable in a longitudinal direction relative to the or each longitudinal rail element, and is preferably slidable along the or each longitudinal rail element in a longitudinal direction. This allows the or each hinge-recess guide element to be selectively located at any longitudinal position along the length of the or each longitudinal rail element.

The hinge-recess guide element(s) and connector element(s) are separate, distinct components. The or each hinge-recess guide element is movable relative to and independently of the or each connector element.

The at least two rail members of each longitudinal rail element may be connectable in an end-on manner. That is, the two rail members are connected such that respective ends of the rail members in the longitudinal direction abut each other. This permits the rail members to form a longitudinal rail element having a continuous profile along substantially its entire length.

The or each connector element may be a separate component arranged to engage with two adjacent rail members so as to connect said two adjacent rail members together. Alternatively, the or each connector element may be formed integrally with a respective rail member and engages with another rail member so as to connect the two rail members together.

Each rail member forming the or each respective longitudinal rail element may have a cross-sectional profile corresponding to that of the other rail member or rail members of the same longitudinal rail element, in at least a part of said rail member. Accordingly, a hinge-recess guide element is able to engage with any one of the rail members in the same manner, thus enabling the hinge-recess guide elements to engage with the longitudinal rail element in the same way at different locations along the length of the longitudinal rail element.

The corresponding cross-sectional profiles of each rail member may be present along the entire length of said rail member. That is, each rail member has a uniform cross-sectional profile along its entire length, and the cross-sectional profile of each rail member forming the longitudinal rail element is identical to that of the other rail member or rail members forming the same longitudinal rail element. Accordingly, a hinge-recess guide element can be connected with each rail member in the same manner, at any position along the length of that rail member. When rail members are connected in an end-on manner to form the longitudinal rail element, the longitudinal rail element is thereby 25 provided with a uniform cross-section along its length. Each hinge-recess guide element can therefore be engaged with the or each longitudinal rail element in the same manner regardless of the longitudinal position of the hinge-recess guide element.

In some embodiments, each rail member comprises an engagement portion; the engagement means of the at least one hinge-recess guide element is arranged to engage with the engagement portion of a rail member so as to set a longitudinal position of the hinge-recess guide element on the longitudinal rail element; and, in use, the at least one connector element is remote from the engagement portion of each rail member.

In one embodiment the engagement portions of the rail members of each longitudinal rail element collectively define an engagement portion of said longitudinal rail element. The engagement portion of said longitudinal rail element may extend continuously along substantially the entire length of said longitudinal rail element. Accordingly, the or each longitudinal rail element comprises an engagement portion extending continuously along substantially the entire length of the longitudinal rail element; the engagement means of the at least one hinge-recess guide element is arranged to engage with the engagement portion so as to set a longitudinal position of the hinge-recess guide element on the longitudinal rail element; and the at least one connector element is remote from the engagement portion of the longitudinal rail element, in use. The at least one connector element may be arranged to engage with the two respective rail members of the longitudinal rail element at a position remote from the engagement portion of the longitudinal rail element.

In such embodiments, the hinge-recess guide element(s) may be engaged with the engagement portions at any longitudinal position of the longitudinal rail element in which the engagement portions of the rail members are present. Since the connector element is remote from the engagement portion, the or each connector element does not interfere with or prevent engagement of the hinge-recess guide elements with the engagement portion at the desired location. With this arrangement, it is possible for the engagement means to engage with the longitudinal rail element at a longitudinal position corresponding to or overlapping with the longitudinal position of the connector element. The hinge-recess guide elements can thereby be located at a desired longitudinal position, without interference of the connector element, and the versatility of the hinge jig is thereby further improved.

In some embodiments, the longitudinal rail element is a first longitudinal rail element, the elongate body further comprising a second longitudinal rail element spaced apart from the first longitudinal rail element so as to define the recess guide region therebetween. Accordingly, in use, the or each hinge-recess guide element is located between the first and second longitudinal rail elements and the space between the first and second longitudinal rail elements defines the recess guide region. The or each connector element is remote from the space between the first and second longitudinal rail elements, such that a hinge-recess guide element may be located between the first and second longitudinal rail elements at any longitudinal position without obstruction by the connector element(s). In this regard, it is to be understood that the recess guide region is defined as the space between innermost faces of the first and second longitudinal rail elements. The recess guide region does not include any channels formed in the longitudinal rail element(s) which may be open to the recess guide region.

The second longitudinal rail element may be identical to the first longitudinal rail element.

The elongate body of the hinge jig may comprise a first sub-assembly comprising a first pair of spaced-apart rail members and a second sub-assembly comprising a second pair of spaced-apart rail members. In use, a respective one of the first pair of rail members is connected to a respective one of the second pair of rail members by means of a connector element so as to at least partially define the first longitudinal rail element. The other respective one of the first pair of rail members is connected to the other respective one of the second pair of rail members by means of a separate connector element so as to at least partially define the second longitudinal rail element. Accordingly, the two sub-assemblies can be connected together to at least partially define the elongate body. The elongate body may comprise more than two sub-assemblies.

The or each connector element may be an elongate member arranged, in use, to bridge between two adjacent rail members and engage with each said rail member so as to connect said rails members together in an end-on manner, wherein a transverse dimension of the or each connector element is less than a transverse dimension of the or each longitudinal rail element. In this context, the elongate body of the hinge jig has a longitudinal direction corresponding to the longest dimension of the elongate body, a transverse direction perpendicular to the longitudinal direction and corresponding to the direction in which the or each hinge-recess guide element extends from the or each longitudinal rail element, in use. The elongate body also has a height direction, which is a direction perpendicular to the longitudinal direction and the transverse direction. The transverse dimension of each component is therefore a dimension of that component which, in use, extends in the transverse direction.

Where the connector element has a transverse dimension which is less than the transverse dimension of the longitudinal rail element, it is possible for the connector element to be received within a channel formed in one of the longitudinal rail elements without projecting into the recess guide region. The or each connector element may be wholly received within a channel of a respective one of the longitudinal rail elements.

In embodiments in which the or each connector element is engaged with rail members by fastening means, said fastening means may have, in use, a transverse dimension which is less than the transverse dimension of the longitudinal rail element. This ensures that both the connector element itself and any fastening means used to engage the connector element with the rail members do not project into the recess guide region or interfere with the engagement of a hinge recess guide element with the longitudinal rail element.

The hinge-recess guide element may, in use, be engaged with the or each longitudinal rail element on a first side of said longitudinal rail element and the connector element engages with the respective rail members on a side of the longitudinal rail element different to first side. Accordingly, it can be ensured that the connector element does not obstruct or interfere with the engagement of the engagement means with the longitudinal rail element. In some embodiments, the connector element engages with the respective rail members on a second side of the longitudinal rail element opposing the first side. In this context, “opposing” is to be interpreted as facing in an opposite direction to the first side. The first side is therefore a side which faces towards the recess guide region, and the second side is a side which faces in an opposite direction.

The or each longitudinal rail element may comprise an engagement channel for receiving the engagement means. The engagement channel may extend continuously along substantially the entire length of the longitudinal rail element. In some embodiments, each rail member may comprise an engagement channel, wherein the engagement channels of the rail members forming a respective longitudinal rail element collectively define the engagement channel of that longitudinal rail element. The engagement channel may extend continuously between adjacent rail members connected together to form the or one of the longitudinal rail elements.

The engagement means of the at least one hinge-recess guide element may comprise a head portion arranged to engage an inner wall of the engagement channel of a respective longitudinal rail element so as to clamp the hinge-recess guide assembly to that respective longitudinal rail element. In such embodiments, the inner wall of the engagement channel forms an engagement portion of the longitudinal rail element.

The or each longitudinal rail element may comprise a connector channel or recess for receiving the connector element. The connector channel or recess may extend continuously along substantially the entire length of the longitudinal rail element. In some embodiments, each rail member may comprise a connector channel or recess, wherein the connector channels or recesses of the rail members forming a respective longitudinal rail element collectively define the connector channel or recess of that longitudinal rail element. The connector channel or recess may extend continuously between adjacent rail members. The connector element may be an elongate plate arranged to be at least partially received within the connector channel or recess.

The engagement channel and/or connector channel may be T-shaped.

In some embodiments, the connector channel may be open to the engagement channel. The or each longitudinal rail element may comprise a single channel defining both the engagement channel and the connector channel, said single channel being arranged to receive both the engagement means of a hinge-recess guide element and a connector element. Alternatively, the connector channel may be separate from the engagement channel.

The engagement channel, connector channel and connector element may be arranged such that, when received within the connector channel, the connector element does not extend into the engagement channel.

In one embodiment, the connector channel may be separate from the engagement channel and open to the engagement channel. Accordingly, the connector channel and engagement channel are distinct channels for receiving and retaining the connector element and engagement means of a hinge-recess guide element, respectively. The or each longitudinal rail element may comprise one or more flanges arranged to separate the engagement channel from the connector channel. The or each longitudinal rail element may comprise an upper flange and/or a lower flange defining the engagement channel on one side thereof and the connector channel on the other side thereof.

In one embodiment, the or each longitudinal rail element comprises an engagement channel on a first side of the longitudinal rail element and a connector channel or recess on a second side of the longitudinal rail element opposing the first side, wherein the connector channel or recess is separated from the engagement channel by a central wall. Accordingly, a connector element received within the connector channel is remote from the engagement channel and thus does not interfere with or obstruct the engagement of the hinge-recess guide element(s) with the engagement channel.

The connector channel or recess may have a dimension in a height direction that is greater than a dimension of the engagement channel in a height direction. With such an arrangement, it is possible for a connector element accommodated within the connector channel to engage with the rail member at a position which does not overlap with the engagement channel. This allows engagement of the connector element with the respective rail member at a position which may have an increased thickness in the transverse direction, whilst allowing the overall thickness of the rail member (and thus the longitudinal rail element) to be minimised.

The connector element may extend in the longitudinal direction and comprises fastening means arranged to engage the connector element with each of the two respective rail members which the connector element connects, in use, so as to fix the position of the connector element relative to each of the rail members and thereby connect the two rail members together, wherein at least one fastening means is provided for each rail member. The fastening means may comprise threaded screws, optionally grub screws.

Each fastening means may extend through the connector element to engage with a respective rail member.

In some embodiments, each fastening means is arranged to extend through the connector element and to bear against a first internal surface of the connector channel, the connector channel comprises a second internal surface facing the first internal surface, and the connector element is arranged to bear against the second internal surface when the fastening means bears against the first internal surface. Accordingly, the connector element can be fastened by inserting the fastening means through the connector element (for example by screwing the fastening means through a threaded bore) such that an end of the fastening means bears against the first internal surface. As the fastening means is further inserted, the connector element is forced away from the first internal surface until it engages with the second internal surface. Once the fastening means has been sufficiently inserted, the connector element is held in place between the first and second internal surfaces of the connector channel. Such embodiments are advantageous because the fastening means need only be loosened sufficiently to disengage the connector element. Complete removal of the fastening means is not necessarily required.

The first internal surface of the connector channel may comprise at least one recess arranged to accommodate a bearing portion of the fastening means. Such recesses can be used to locate the fastening means in the correct position and to prevent longitudinal movement of the connector element once engaged within the connector channel.

In other embodiments, each respective rail member comprises a threaded bore in communication with the connector channel and arranged to receive a respective fastening means. Accordingly, the fastening means can securely engage with the rail member to fixedly connect the connector element with the rail member.

In some embodiments, the hinge jig may comprise at least two hinge-recess guide elements arranged to define the guide channel therebetween, wherein at least one of the guide channel elements is slidable along the longitudinal rail element to adjust the length of the guide channel to match or substantially match a hinge length. Alternatively or additionally, the hinge jig may comprise a hinge-recess guide element comprising a central opening defining a guide channel. The central opening may be adjustable so as to permit the size of the guide channel to be adjusted.

Non-limiting embodiments of the invention will now be described, by way of example only, with reference to the accompanying drawings in which:

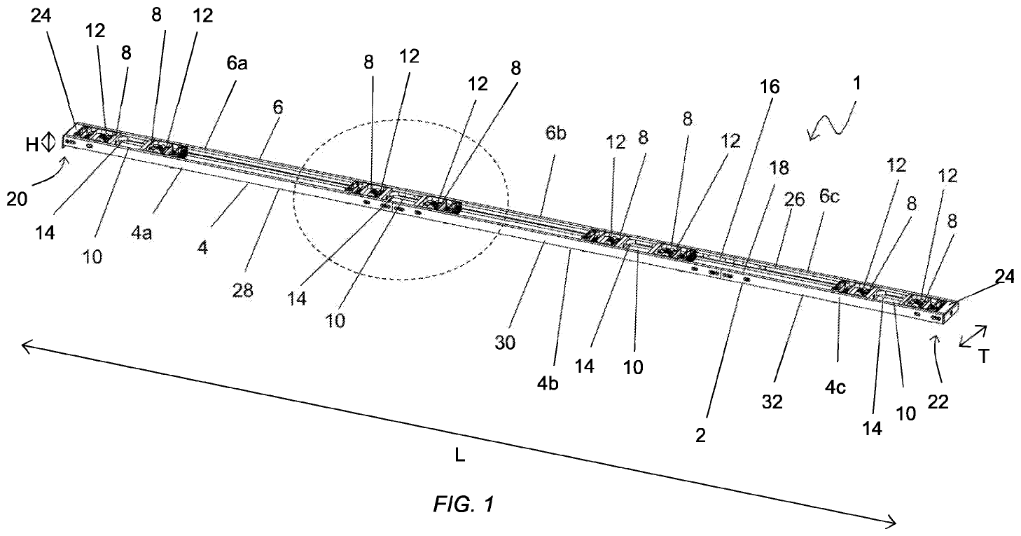

FIG. 1 is a perspective view of a door-hinge jig according to the present invention;

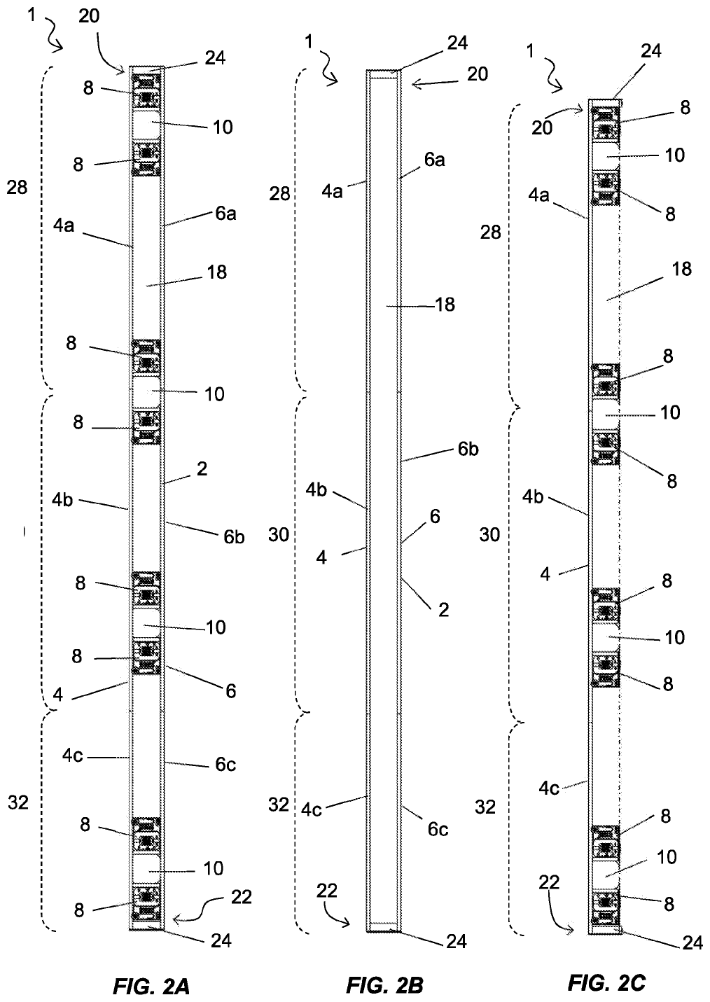

FIG. 2A is a plan view of the hinge jig of FIG. 1;

FIG. 2B is a plan view of the hinge jig of FIGS. 1 and 2A, with hinge-recess guide elements removed;

FIG. 2C is a plan view of a hinge jig according to a further embodiment of the present invention;

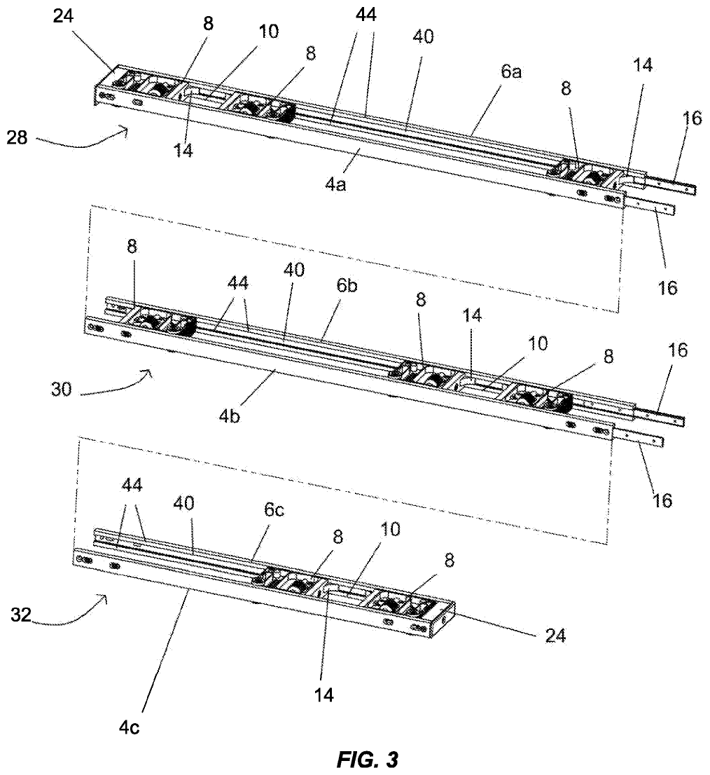

FIG. 3 is an exploded perspective view of the hinge jig of FIG. 1;

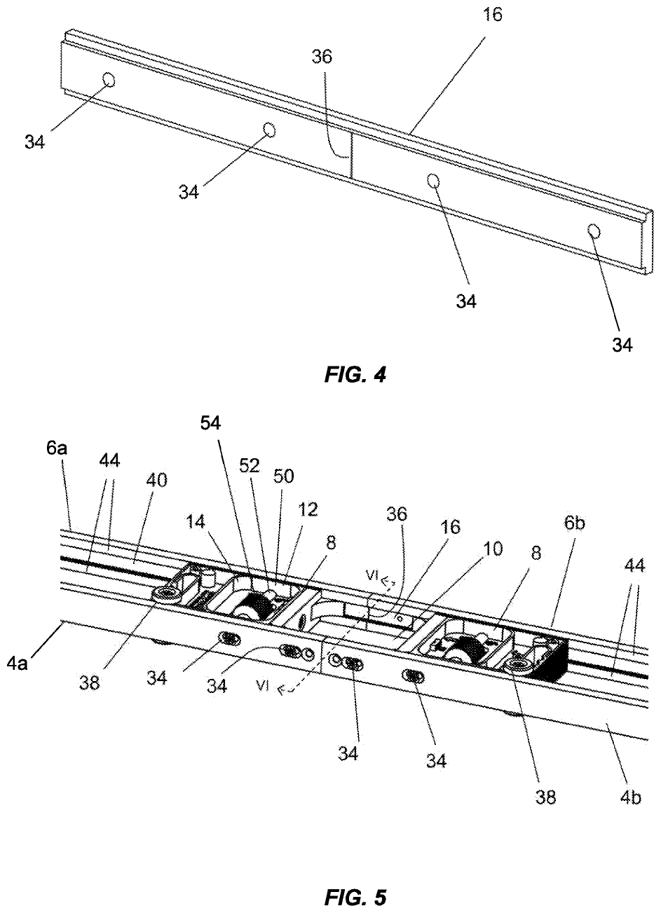

FIG. 4 is an enlarged perspective view of a connector element of the hinge jig of FIG. 1;

FIG. 5 is an enlarged view of the circled area of the hinge jig of FIG. 1;

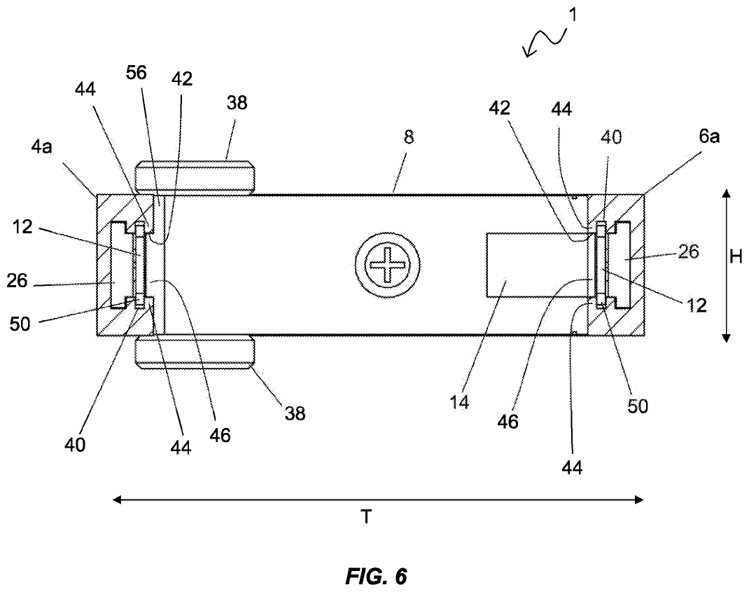

FIG. 6 is a cross section through line VI-VI shown in FIG. 5;

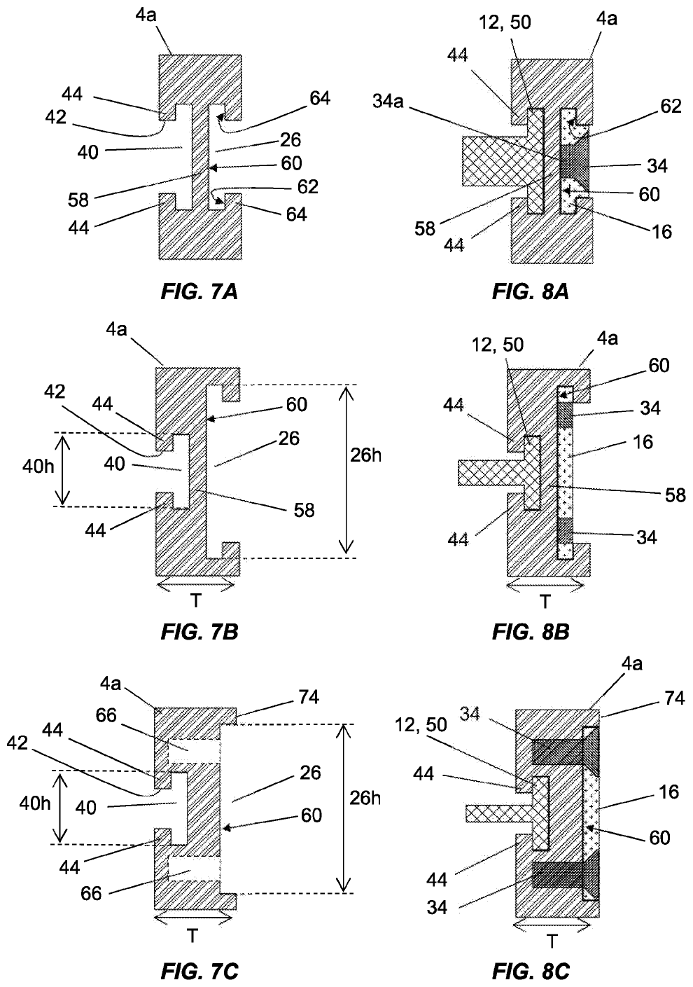

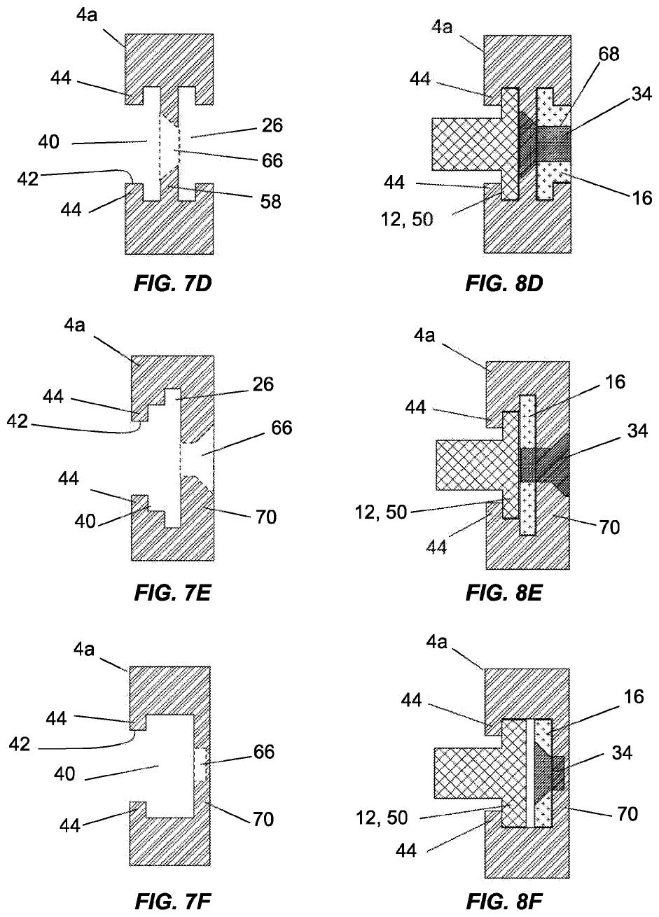

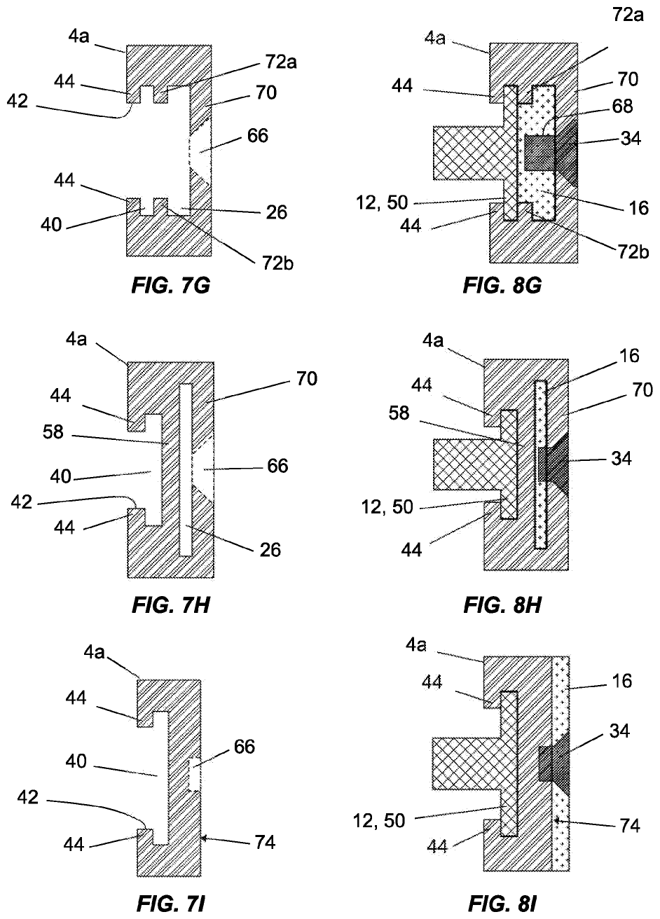

FIGS. 7A to 7I are cross-sections of various embodiments of the longitudinal rail element of a hinge jig in accordance with the present invention; and

FIGS. 8A to 8I are cross-sections of the longitudinal rail elements shown in FIGS. 7A to 7I, in use.

With reference to FIG. 1, there is shown a door-hinge jig 1 for forming hinge-receiving recesses in a door edge or door frame. The jig 1 comprises an elongate body 2 having a longitudinal direction L, a transverse direction T and a height direction H. The elongate body 2 comprises a first longitudinal rail element 4 and a second longitudinal rail element 6. Each of the first and second longitudinal rail elements 4, 6 comprises three rail members 4a, 4b, 4c, 6a, 6b, 6c connected in an end-on manner such that respective ends of the rail members abut. Accordingly, a first set of rail members 4a, 4b, 4c defines the first longitudinal rail element 4 as a continuous structure and a second set of rail members 6a, 6b, 6c defines the second longitudinal rail element 6 as a continuous structure. It will be appreciated that each of the first and second longitudinal rail elements 4, 6 could be formed of a different number of rail members, for example two rail members. Each of the rail members may be formed of any sufficiently rigid material and is may be extruded aluminium.

The jig 1 further comprises a plurality of hinge-recess guide elements 8 defining a plurality of guide channels 10 for forming a hinge recess in a door edge or door frame. Each hinge-recess guide element 8 comprises engagement means 12 for engaging the hinge-recess guide element 8 with the first and second longitudinal rail elements 4, 6 to set a longitudinal position of the hinge-recess guide element 8 on the elongate body 2. The engagement means 12 of the illustrated embodiment will be described in greater detail below.

Respective pairs of guide elements 8 form each channel 10, but could be a single guide element 8 forming a single channel 10.

Each guide channel 10 defined by the hinge-recess guide elements 8 provides a guide for forming a recess in a door edge or door frame using a router. The cutters of routers are generally cylindrical. Accordingly, where the guide channel 10 is substantially rectangular in form (i.e. with 90 degree corners), the resulting recess with have rounded edges having a radius corresponding to the radius of the cylindrical cutter. In order to provide rounded corners having different radii, a plurality of detachable adapters 14 are provided which can be fitted to the hinge-recess guide elements 8 to define the radius of the rounded corners of the recess, as shown most clearly in FIG. 3. A plurality of interchangeable adapters may be provided to allow recesses with difference radii to be formed. It will be appreciated that the minimum radius of the corner will be defined by the radius of the router cutter. If squared corners are desired, the corners of the recess can be subsequently squared using a chisel tool.

A plurality of connector elements 16 are provided to connect adjacent rail members 4a, 4b, 4c, 6a, 6b, 6c together in an end-on manner to be in an abutting relationship. In the illustrated embodiment, each of the first and second longitudinal rail elements 4, 6 comprises three rail members 4a, 4b, 4c, 6a, 6b, 6c and two connector elements 16.

Each connector element 16 is arranged such that when the rail members 4a, 4b, 4c, 6a, 6b, 6c are connected in an end-on manner to form a respective longitudinal rail element 4, 6, the engagement means 12 of each hinge-recess guide element 8 is permitted to engage with the longitudinal rail element 4, 6 at any longitudinal position of the longitudinal rail element 4, 6. In other words, the connector element 16 does not interfere with the engagement of the hinge-recess guide elements 8 with the longitudinal rail elements 4, 6, regardless of the longitudinal position at which the engagement means 12 engage with the longitudinal rail elements 4, 6. Accordingly, the hinge-recess guide elements 12 are permitted to be positioned anywhere along the length of the elongate body 2 and the guide channels 10 can thereby be positioned at any desired longitudinal position. This allows the hinge jig 1 to be used to form hinge-receiving recesses at any position along the length of a door edge or door frame. At the same time, the provision of multiple rail members 4a, 4b, 4c, 6a, 6b, 6c allows the elongate body 2 of the jig 1 to be disassembled for storage.

In order to achieve this, the jig 1 defines a recess guide region 18 which extends continuously along substantially the entire length of the first and second longitudinal rail elements 4, 6. When the hinge jig 1 is assembled, each hinge-recess guide element 8 is located within the recess guide region 18 and each connector element 16 is remote from the recess guide region 18. That is, the recess guide region 18 is the region of the jig 1 in which the hinge-recess guide elements 8 may be located, in use. The connector element 16 does not occupy any space within the recess guide region 18.

FIGS. 2A and 2B show the hinge jig 1 of FIG. 1 in plan view. FIG. 2A shows the hinge jig 1 with hinge-recess guide elements 8 accommodated within the recess guide region 18, whilst FIG. 2B shows the hinge jig 1 without any hinge-recess guide elements inserted. As shown in FIG. 2B, the recess guide region 18 extends continuously along substantially the entire length of the first and second longitudinal guide elements 4, 6. That is, the recess guide region 18 extends from a first end region 20 of the elongate body 2 to a second end region 22 of the elongate body 2 without interruption.

In the illustrated embodiment, the recess guide region 18 is defined by the space between the opposing first and second longitudinal rail elements 4, 6. However, in some embodiments (see FIG. 2C) only a single longitudinal rail element 4 may be provided, in which case the recess guide region 18 will be the region adjacent the longitudinal guide element 4 in which the hinge recess guide elements 8 may be located when engaged with the longitudinal rail element 4. The recess guide region 18 is indicated with a dashed line i.e. the area in which hinge-recess guide elements 8 may be located, in use.

Referring again to the embodiment of FIGS. 1, 2A and 2B, the first and second longitudinal rail elements 4, 6 are spaced apart to define the recess guide region 18 therebetween. Each hinge-recess guide element 8 is located within the recess guide region 18, and defines the spacing between the first and second longitudinal rail elements 4, 6 (that is, a transverse dimension of the recess guide region 18). The jig 1 further comprises two end cross members 24 connecting the first and second longitudinal rail elements 4, 5 at their longitudinal ends and also acting in combination with the hinge-recess guide elements 8 to define the spacing between the first and second longitudinal rail elements 4, 6. The end cross members 24 are preferably solid plastics or metal.

As shown in FIG. 1, each connector element 16 is wholly received within a connector channel 26 of a respective one of the first or second longitudinal rail elements 4, 6. The connector channel 26 is located such that the connector element 16 received within the connector channel 26 is remote from the recess guide region 18. Accordingly, the connector elements 16 do not project into or otherwise obstruct the recess guide region 18 and therefore do not interfere with the positioning of the hinge-recess guide elements 8. Accordingly, the hinge-recess guide elements 8, and the guide channels 10 defined thereby, can be positioned at any desired location along the length of the elongate body 2 without restriction. It will be appreciated that alternative configurations may be adopted in order to ensure that each connector element 16 is remote from the recess guide region 18, examples of which will be described below.

Referring to FIGS. 1 and 3, in particular, the elongate body 2 is formed of three sub-assemblies 28, 30, 32, each defined by respective pairs of spaced apart rail members. Each pair of spaced apart rail members comprises one rail member of each of the first and second longitudinal rail elements 4, 6. A first sub-assembly 28 is defined by a first pair of the rail members 4a, 6a, a second sub-assembly 30 is defined by a second pair of the rail members 4b, 6b and a third sub-assembly 32 is defined by a third pair of the rails members 4c, 6c. The sub-assemblies 28, 30, 32 are connected as illustrated in FIG. 3 in order to form the elongate body 2.

As shown in FIG. 3, prior to connecting the sub-assemblies, the connector elements 16 can be housed within the connector channel 26 of one of the rail members 4b for storage. Accordingly, there is no need to remove the connector elements 16 from the connector channel 26 at any stage during storage of the hinge jig 1 in a disassembled configuration. This prevents accidental loss or misplacement of the connector elements 16.

With reference to FIGS. 4 and 5, each connector element 16 is an elongate plate arranged to bridge between two adjacent rail members 4a, 4b and engage with each of the two adjacent rail members 4a, 4b in order to connect the two rail members 4a, 4b together in an abutting relationship. A plurality of screws 34 are provided to engage the connector element 16 with the rail members 4a, 4b as will be described in greater detail below. The connector element 16 thereby secures the two adjacent rail members 4a, 4b together in an end-on manner as shown in FIG. 5, which is an enlarged view of the circled region in FIG. 1.

In the illustrated embodiment, the connector element 16 comprises an etched line 36 at the longitudinal centre of the connector element 16. The etched line 36 enables the connector element 16 to be correctly aligned within the connector channel 26 so as to ensure proper engagement of the connector element 16 with the two rail members 4a, 4b. For instance, each of the rail members 4a, 4b may comprise threaded bores (not shown) into which the screws 34 are threaded in order to engage the connector element 16 with each of the rail members 4a, 4b. The rail members 4a, 4b may alternatively comprise recesses (not shown) to receive end portions of the screws 34 so as to prevent longitudinal movement of the connector element 16. Accordingly, the etched line 36 permits accurate alignment of the connector element 16 to ensure correct engagement of the screws 34 with the threaded bores or recesses. Even in the absence of threaded bores or recesses, the etched line 36 may help to ensure that the connector element 16 is evenly distributed between the two rail elements 4a, 4b to ensure a reliable connection.

Each hinge-recess guide element 8 is provided with a guide bush 38 which can be used to act as a stop to define a transverse dimension of the recess. The guide bushes 38 can be set at different locations in the transverse direction on the hinge-recess guide elements 8 in order to set the desired transverse dimension of the recess.

FIG. 6 shows the jig 1 in cross-section through line VI-VI indicated in FIG. 5. Each of the opposing rail members 4a, 6a comprises a T-shaped engagement channel 40 having a mouth 42 defined by two lips 44. The lips 44 form an engagement portion of the rail members 4a, 6a. When the rail members 4a, 6a are connected together as described above, the respective engagement portions of each of the connected rail members combine to form an engagement portion of the respective longitudinal rail element 4, 6 that extends continuously along substantially the entire length of that longitudinal rail element 4, 6. This can be seen with reference to FIG. 5, wherein the lips 44 of adjacent rail members 6a, 6b combine to form a continuous engagement portion of the longitudinal rail element 6.

Referring again to FIG. 6, each hinge-recess guide element 8 includes a runner 46 which is slidably received in the mouth 42 of the engagement channel 40. The runner 46 has an elongate extent, thereby preventing or limiting rotation of the hinge-recess guide element 8 relative to the longitudinal rail element 4, 6. Preferably, each hinge-recess guide element 8 may be plastics, but metal is also feasible.

The hinge-recess guide element 8 further comprises an engagement means 12 arranged to engage with the with the engagement portion 44 of each longitudinal rail element 4, 6 so as to set a longitudinal position of the hinge-recess guide element 8 on that longitudinal rail element 4, 6. In the illustrated embodiment, each engagement means 12 comprises a head 50 slidably received within the engagement channel 40. The head 50 has a dimension in the height direction H which is greater than a corresponding dimension of the mouth 42 of the engagement channel 40, thereby preventing removal of the head 50 from the engagement channel 40 by movement in the transverse direction T. Each head 50 is also preferably non-circular to prevent or limit rotation within the engagement channel 40.

Referring again to FIG. 5, the head 50 of each engagement means 12 is fixedly connected to a threaded shaft 52 received within a rotatable adjuster 54, arranged such that rotation of the rotatable adjuster 54 effects movement of the threaded shaft 52 in an axial direction of the shaft (corresponding to the transverse dimension T of the jig 1). Accordingly, rotation of the rotatable adjuster 54 causes the head 50 to engage with the lips 44 of the engagement channel 40 so as to clamp the lips 44 between the head 50 of the engagement means 48 and shoulders 56 of the hinge-recess guide element 8, thereby fixing the longitudinal position of the hinge-recess guide element 8.

The mechanism by which the engagement means of the hinge-recess guide element engages with the engagement portion of the longitudinal rail element is not particularly critical and one such arrangement is described in detail in UK Patent No. GB2490139.

Various configurations of the connector element 16 will now be described with reference to FIGS. 7A to 71 and FIGS. 8A to 81. FIGS. 7A to 71 show different embodiments of a rail member 4a in cross section. FIGS. 8A to 81 show the same rail members, with an engagement means 12 and connector element 16 simultaneously engaged with the rail member 4a at the same longitudinal position along the length of the rail member 4a. Corresponding features are indicated with like numerals.

In the embodiment of FIG. 7A, the rail member 4a comprises an engagement channel 40 for engaging the hinge-recess guide element 8 as described above. Opposing lips 44 of the engagement channel 40 define an engagement portion which extends substantially along the entire length of the longitudinal rail element 4, so as to permit the hinge-recess guide elements 8 to be positioned at any desired longitudinal position. The engagement means 12 comprises a head 50 received within the engagement channel 40, so as to engage with the engagement portion defined by lips 44 in the manner described above.

The rail member 4a further comprises a connector channel 26 separated from the engagement channel 40 by a central wall 58. In use (FIG. 8A), the connector element 16 is received within the connector channel 26 and is thus remote from the engagement channel 40 and the engagement portion defined by lips 44. Accordingly, the connector element 16 does not interfere with the positioning of the hinge-recess guide elements 8.

The engagement channel 40 is provided on a first side of the rail member 4a (and thus on a first side of the longitudinal rail element 4 of which the rail member 4a is a component) and the connector channel 26 is provided on a second side of the of the longitudinal rail element 4, the second side opposing the first side (that is, the second side faces in an opposite direction to the first side). Accordingly, the connector element 16 is remote from the side of the rail member 4a with which the hinge-recess guide elements 8 engage and thus does not interfere with their engagement.

The engagement channel 40 is T-shaped in cross section. The engagement means 12 is received within the engagement channel 40 and engages with the engagement portion defined by lips 44 in the manner described above.

The connector channel 26 is T-shaped in cross-section and the connector element 16 has a corresponding shape so as to be accommodated within the connector channel 26. Sufficient clearance is provided to permit movement of the connector element 16 along the connector channel 26 when the connector element is not engaged with the rail member 4a. A screw 34, for example a grub screw, extends through the connector element 16 and bears against a surface 60 of the central wall 58 that defines an inner surface of the connector channel 26. Top and bottom portions (in the orientation shown in FIG. 7A) of the connector element 16 are thereby forced against an opposing internal surface 62 of the connector channel 26 defined by two lips 64 of the connector channel 26, so as to secure the connector element 16 against the rail member 4a. The connector element 16 is held in place by friction. The connector element 16 can be further prevented from longitudinal movement by the provision of recesses (not shown) on the inner surface 60 of the connector channel 26 with which the screws 34 engage, in which recess the distal ends 34a of the screws 34 can be received in order to prevent longitudinal movement of the connector element 16 along the connector channel 26.

It will be appreciated that the strength of the rail member 4a at the point of engagement with the screw 34 must be sufficient to prevent distortion of the rail member when the screw 34 is tightened to bear against the rail member 4a. Accordingly, the material and thickness (i.e. the dimension in the transverse direction) of the rail member 4a must be selected to provide sufficient strength. In the embodiment of FIG. 7A, the point of engagement of the screw 34 is located on the central wall 58 and thus the material and thickness of the central wall 58 must be sufficient to prevent distortion.

FIG. 7B shows a further embodiment similar to that of FIG. 7A. The rail member comprises an engagement channel 40 and a connector channel 26 separated from the engagement channel 40 by a central wall 58. The connector channel 26 has a dimension 26h in the height direction H which is greater than the corresponding dimension 40h of the engagement channel 40. With reference to FIG. 8B, this arrangement allows for screws 34 to extend through the connector element 16 and bear against the inner surface 60 of the connector channel 26 at positions in the height direction that do not overlap with the engagement channel 40 in the height direction i.e. at positions above and below the central wall 58. As can be seen from FIGS. 7B and 8B, this allows the thickness of the rail member 4a at the point of engagement of the screws 34 to be greater compared to the arrangement of FIG. 7A, where the screw 34 bears against the central wall 58 separating the engagement channel 40 and the connector channel 26. Thus the strength of the rail member 4a at the point of engagement with the screw 34 is greater for the arrangement of FIGS. 7B and 8B, without the need to increase the thickness of the central wall 58. Accordingly, the overall dimension of the rail member 4a in the transverse direction T can be minimised, without compromising the strength of the rail member 4a at the point of engagement.

FIGS. 7C and 8C show a similar arrangement to that of FIGS. 7B and 8B., however in this case the rail member 4a comprises a threaded bore 66 arranged to receive the screw 34 so as to engage the connector element 16 with the rail member 4a. In order to permit the overall dimensions of the rail member 4a to be minimised (in particular the dimension in the transverse direction), the connector channel 26 has a dimension 26h in the height direction H that is greater than a corresponding dimension 40h of the engagement channel 40. Accordingly, the screw 34 can engage at a position in the height direction H that does not overlap with the engagement channel 40. That is, the screw 34 engages with the rail member 4a above and below the central wall 58 separating the engagement channel 40 and the connector channel 26. In much the same manner as the embodiment of FIGS. 7B and 8B, the embodiment of FIGS. 7C and 8C allows a firm engagement on the connector element 16 with the rail member 4a, whilst allowing the dimension of the rail member 4a in the transverse direction T to be minimised.

In this embodiment, the connector channel 26 is in the form of a recess formed in an external face 74 of the rail member 4a that is remote from the engagement portion formed by lips 44, and thus remote from the engagement channel 40. The connector element 16 is secured within the recess by means of screws 34.

FIGS. 7D and 8D show another arrangement of the rail member 4a similar to that of FIG. 7A. In this case, a bore 66 is formed through the central wall 58 of the rail member 4a permitting a screw 34 to be inserted through the central wall 58 from the engagement channel 40 to engage with a threaded bore 68 in the connector element 16. The connector element 16 is thereby secured in place. The bore 66 formed in the central wall 58 is arranged to fully receive a head of the screw 34 such that the screw 34, once engaged with the connector element, does not protrude into the engagement channel 40. Accordingly, the engagement channel 40 remains free from obstruction, permitting the engagement means 12 of a hinge-recess guide element to be positioned anywhere within the engagement channel 40 along the entire length of the longitudinal rail element 4.

A further arrangement is shown in FIGS. 7E and 8E. Here, the connector element 16 is received within a connector channel 26 that opens to the engagement channel 40. That is to say, there is no central wall separating the engagement channel 40 and the connector channel 26. The connector element 16 therefore engages with the rail member 4a on the same side of the rail member 4a as the engagement means of the hinge-recess guide element (not shown), that is the first side of the rail member 4a.

A threaded bore 66 is provided in an external wall 70 of the rail member 4a, through which a screw 34 extends to engage with the connector element 16 to retain the connector element 16 in place. It will be appreciated that the screw 34 could be arranged to extend through the connector element 16 from the first side to bear against an inner surface of the external wall 70 or to be received within the threaded bore 68. However, in such embodiments it is preferable that the screw 34 is permitted to be received within the connector element 16 such that no part of the screw 34 extends or protrudes into the engagement channel 40.

Whilst the engagement channel 40 and the connector channel 26 are in communication (i.e. there is no central wall between the engagement channel 40 and the connector channel 26), the connector channel 26 and the engagement channel 40 are separate channels arranged to receive the connector element 16 and engagement means 12, respectively. The connector element 16 is arranged to be received wholly within the connector channel 26 such that it does not extend or protrude into the engagement channel 40. The engagement channel 40 thereby remains unobstructed by the connector element 16 and the connector element 16 is remote from the engagement channel 40, the engagement portion 44 defined by lips of the engagement channel 40, and the recess guide region 18.

FIGS. 7F and 8F show another arrangement of the rail member 4a, in which a single channel 40 is provided, which is large enough to receive both the connector element 16 and the engagement means 12 of the hinge-recess guide element 8, without the connector element 16 obstructing the engagement means 12. Accordingly, the engagement means 12 can engage with the engagement portion 44 of the rail member 4a at any longitudinal position, regardless of whether a connector element 16 is present at the same longitudinal position.

In the arrangement of FIGS. 7F and 8F, the connector element 16 engages with an external wall 70 of the rail member 4a by means of a screw 34 extending through the connector element 16 into a threaded bore 66 provided in the external wall 70. It will be appreciated that the connector element 16 may engage with the rail member 4a in other ways, for example the screw may extend through the external wall 70 from the outside to be received within a threaded bore in the connector element 16.

FIGS. 7G and 8G show a further embodiment of the rail member 4a, comprising a connector channel 26 that is open to and separate from an engagement channel 40. The rail member 4a comprises an upper flange 72a and a lower flange 72b separating the connector channel 26 from the engagement channel 40. As shown in FIG. 8G, the engagement channel 40, connector channel 26 and connector element 16 are arranged such that, when the connector element 16 is received within the connector channel 26, the connector element 16 does not extend into the engagement channel 40. The upper flange 72a and lower flange 72b define a T-shaped connector channel 26 for receiving a T-shaped connector element 16.

With this arrangement, the connector element 16 is remote from the engagement channel 40 and, importantly, from the engagement portion defined by lips 44 of the rail member 4a. Accordingly, the connector element 16 does not obstruct the engagement means 12 from engaging with the engagement portion (lips 44). The arrangement enables the connector element 16 to be easily fastened to and unfastened from the rail member 4a by means of screw 34, which the user can access from an external location. At the same time, the engagement of the connector element 16 with the rail member 4a is secure, without requiring the rail member 4a to be formed of particularly robust materials and without the need to increase the overall dimensions of the rail member 4a. The rail member 4a can be formed of aluminium, for example. Furthermore, the cross-sectional profile of the rail member 4a can be easily formed by extrusion, for example, whilst ensuring that the structural requirements of the hinge jig are met (i.e. the connector element 16 remains remote from the recess guide region of the hinge jig).

The connector element 16 is secured within the connector channel 26 by means of a screw 34 extending through a bore 66 in an external wall 70 of the rail member 4a into a threaded bore 68 of the connector element 16.

FIGS. 7H and 8H show an embodiment of the rail member 4a in which the connector channel 26 is an internal cavity of the rail member 4a. In cross-section, the connector channel 26 is closed. The connector element 16 is in the form of a plate arranged to be received within the connector channel 26 and secured to the rail member 4a by means of a screw 34 extending through a bore 66 in an external wall 70 of the rail member 4a into a threaded bore 68 of the connector element 16. The connector channel 26 is separated from the engagement channel 40 by a central wall 58 of the rail member 4a.

FIGS. 7I and 8I show a further embodiment of the rail member 4a, comprising an engagement channel 40 arranged to receive the engagement means 12 in the manner described above above. The connector element 16 is secured to an external face 74 of the rail member 4a that is remote from the engagement portion formed by lips 44, and thus the connector element 16 is also remote from the engagement channel 40. The connector element 16 is secured to the external face 74 by means of screw 34 which extends through the connector element 16 into a threaded bore 66 formed in the external face 74 of the rail member 4a.

It will be appreciated that in each of the arrangements shown in FIGS. 7A to 81 and described above, the connector element 16 arranged such that when the rail members are connected to form a respective longitudinal rail element, the engagement means of a hinge-recess guide element is permitted to engage with the longitudinal rail element at any longitudinal position of the longitudinal guide element, without any obstruction by the connector element. In each case, the connector element is remote from the recess guide region. To achieve this, the connector element is arranged to engage with the rail member at a position remote from the engagement portion of the longitudinal rail element. It will be appreciated that various arrangements are possible which permit the connector element to be remote from the engagement portion and/or the recess guide region, other than those described above.

The invention has been described above with reference to specific embodiments, given by way of example only. It will be appreciated that different arrangements of the system are possible, which fall within the scope of the appended claims.

1. A door-hinge jig for forming hinge-receiving recesses in a door edge or door frame, the jig comprising:
an elongate body comprising at least one longitudinal rail element, each at least one longitudinal rail element comprising at least two rail members arranged to be connected together to form the respective longitudinal rail element;
at least one hinge-recess guide element at least partially defining a guide channel for forming a hinge recess in a door or doorframe, the at least one hinge-recess guide element comprising engagement means for engaging the at least one hinge-recess guide element with the at least one longitudinal rail element to set a longitudinal position of the hinge-recess guide element on the at least one longitudinal rail element; and
for each at least one longitudinal rail element, at least one connector element arranged to connect together the at least two rail members of the respective longitudinal rail element,
wherein, in use:
the jig defines a recess guide region extending continuously along substantially the entire length of the at least one longitudinal rail element,
the at least one hinge-recess guide element is located within said recess guide region so as to at least partially define a position of a guide channel within said recess guide region, and
the at least one connector element is remote from the recess guide region, such that the at least one hinge-recess guide element is arranged to be selectively positioned within the recess guide region at any longitudinal position along the length of the longitudinal guide element, without obstruction or interference by the at least one connector element.

2. A door-hinge jig according to claim 1, wherein:
each rail member comprises an engagement portion;
the engagement means of the at least one hinge-recess guide element is arranged to engage with the engagement portion of a rail member so as to set a longitudinal position of the hinge-recess guide element on the at least one longitudinal rail element; and
in use, the at least one connector element is remote from the engagement portion of each rail member.

3. A door-hinge jig according to claim 2, wherein the engagement portions of the at least two rail members of each longitudinal rail element collectively define an engagement portion of said longitudinal rail element, the engagement portion of said longitudinal rail element extending continuously along substantially the entire length of said longitudinal rail element.

4. A door-hinge jig according to claim 1, wherein the at least one longitudinal rail element comprises a first longitudinal rail element and a second longitudinal rail element spaced apart from the first longitudinal rail element so as to define the recess guide region between the first and second longitudinal rail elements.

5. (canceled)

6. A door-hinge jig according to claim 4, wherein the elongate body comprises a first sub-assembly comprising a first pair of spaced-apart rail members and a second sub-assembly comprising a second pair of spaced-apart rail members, wherein, in use,
a respective one of the first pair of rail members is connected to a respective one of the second pair of rail members by means of a first connector element of the at least one connector element so as to at least partially define the first longitudinal rail element, and the other respective one of the first pair of rail members is connected to the other respective one of the second pair of rail members by means of a second connector element of the at least one connector element so as to at least partially define the second longitudinal rail element.

7. A door-hinge jig according to claim 1, wherein the at least one connector element is an elongate member arranged, in use, to bridge between two adjacent rail members and engage with each of said two adjacent rail members so as to connect said two adjacent rail members together, wherein a transverse dimension of the at least one connector element is less than a transverse dimension of the at least one longitudinal rail element.

8. A door-hinge jig according to claim 6, wherein the at least one connector element is arranged to be wholly received within a channel of a respective longitudinal rail element.

9. A door-hinge jig according to claim 1, wherein, in use, the hinge-recess guide element is engaged with the at least one longitudinal rail element on a first side of said longitudinal rail element and wherein the connector element engages with the respective rail members on a side of the longitudinal rail element differing from the first side.

10. (canceled)

11. A door-hinge jig according to claim 1, wherein the at least one longitudinal rail element comprises an engagement channel for receiving the engagement means.

12. (canceled)

13. A door-hinge jig according to claim 11, wherein the engagement means of the at least one hinge-recess guide element comprises a head portion arranged to be received with the engagement channel and engage an inner wall of the engagement channel of a respective longitudinal rail element so as to clamp the hinge-recess guide element to that respective longitudinal rail element.

14. A door-hinge jig according to claim 1, wherein the at least one longitudinal rail element comprises a connector channel or recess for receiving the connector element.

15. A door-hinge jig according to claim 14, wherein the connector element comprises an elongate plate arranged to be at least partially received within the connector channel or recess.

16. A door-hinge jig according to claim 14, wherein the at least one longitudinal rail element comprises a connector channel for receiving the at least one connector element separate from the engagement channel.

17. A door-hinge jig according to claim 16, wherein the at least one longitudinal rail element comprises one or more flanges arranged to separate the connector channel from the engagement channel.

18. (canceled)

19. A door hinge jig according to claim 1, wherein the connector element extends in a longitudinal direction and comprises fastening means arranged to engage the connector element with each of the two respective rail members which the connector element connects, in use, so as to fix the position of the connector element relative to each of the two respective rail members and thereby connect the two respective rail members together, wherein at least one fastening means is provided for each rail member of the at least two rail members.

20. A door-hinge jig according to claim 19, wherein the fastening means comprise threaded screws.

21. A door-hinge jig according to claim 19, wherein each fastening means extends through a connector element of the at least one connector element and engages with a respective rail member of the at least two rail members, or extends through a respective rail member of the at least two rail members and engages with the at least one connector element.

22. (canceled)

23. A door-hinge jig according to claim 1, comprising two hinge-recess guide elements arranged to define a guide channel therebetween, wherein at least one of said two hinge-recess guide elements is slidable along the at least one longitudinal rail element to adjust the length of the guide channel to match or substantially match a hinge length.

24. A door-hinge jig according to claim 1, wherein each rail member of the at least one longitudinal rail element has a cross-sectional profile corresponding to a cross-sectional profile of an other rail member of the same longitudinal rail element of the at least one longitudinal rail element.

25. A door-hinge jig according to claim 1, wherein for each longitudinal rail element of the at least one longitudinal rail element, the at least two rail members comprises a plurality of rail members having specific, non-equal lengths.
